(19) United States
(12) Patent Application Publication
(10) Pub. No.: US 2025/0021734 A1
(43) Pub. Date: Jan. 16, 2025

(54) DEFINED CIRCUIT STRUCTURE PATTERN IDENTIFICATION AND PLACEMENT AVOIDANCE

(71) Applicant: International Business Machines Corporation, Armonk, NY (US)

(72) Inventors: Richard Edward SERTON, Charlottesville, VA (US); David WOLPERT, Poughkeepsie, NY (US); Michael Alexander BOWEN, Poughkeepsie, NY (US); Henry A. BONGES, III, Milton, VT (US)

(21) Appl. No.: 18/349,390

(22) Filed: Jul. 10, 2023

(51) Int. Cl. G06F 30/392

(52) U.S. Cl. CPC G06F 30/392; G06F 2119/02

(57) ABSTRACT

Embodiments of the present disclosure provide systems and methods for implementing defined circuit structure pattern identification and placement avoidance in an integrated circuit. Disclosed embodiments identify regions of circuits containing potentially problematic content from review of physical design data of at least a portion of the integrated circuit. The identified circuits containing problematic content along at least one circuit boundary are marked with a keyword. The keyword is maintained with the identified problematic circuit throughout the hierarchical construction of the integrated circuit. The keyword is used to keep the identified problematic circuits spaced apart from other sensitive circuits to avoid performance disruption of adjacent sensitive circuits.

### BACKGROUND

The present invention relates to the integrated circuit design field, and more specifically to defined circuit structure pattern identification and placement avoidance in integrated circuits (ICs).

In a very large-scale integration (VLSI) process of creating electronic circuits, such as an integrated circuit, certain circuit structures can cause deleterious effects on other circuits when placed in proximity in a circuit design layout. For example, certain circuit structures can negatively influence transistor performance of other adjacent circuits. These interactions can take place across a hierarchy of the design construction layers of the circuits. Spacing all circuit blocks far enough apart to avoid this problem wastes significant space.

### SUMMARY

Embodiments of the present disclosure provide systems and methods for implementing defined circuit structure pattern identification and placement avoidance in a semiconductor circuit layout of integrated circuits (ICs).

A non-limiting disclosed computer implemented method comprises accessing physical design data for an integrated circuit; the physical design data comprising predefined circuit shapes forming at least one portion of the integrated circuit. The system performs shape-based checking of the physical design data, based on the predefined circuit shapes, to identify circuit regions containing problematic content. The problematic content corresponds to a defined pattern. The system updates a circuit identification file with a keyword for a first circuit of an identified circuit region containing the problematic content. The keyword comprises a location-specific identifier for the first circuit of at least one circuit boundary containing the defined pattern. The system performs construction-based placement checking, based on the keyword of the first circuit, to determine placement compliance with a predetermined separation space from the at least one circuit boundary to a second circuit in a semiconductor circuit layout of the integrated circuit.

Other disclosed embodiments include a computer control system and computer program product for implementing defined circuit structure pattern identification and placement avoidance in a semiconductor circuit layout of integrated circuits, implementing features of the above-disclosed method.

### BRIEF DESCRIPTION OF THE DRAWINGS

FIG. 1 is a block diagram of an example computer environment for use in conjunction with one or more disclosed embodiments for implementing defined circuit structure pattern identification and placement avoidance in a semiconductor circuit layout of integrated circuits (ICs);

FIG. 2 is a block diagram of an example system for implementing defined circuit structure pattern identification and placement avoidance of one or more embodiments of the present disclosure;

FIG. 3 is a flow chart of an example operations of an example method for implementing defined circuit structure pattern identification and placement avoidance of one or more embodiments of the present disclosure;

FIG. 4 illustrated an example semiconductor circuit layout of one or more embodiments of the present disclosure; and

FIG. 5 is a flow chart of an example method for implementing defined circuit structure pattern identification and placement avoidance of one or more embodiments of the present disclosure.

### DETAILED DESCRIPTION

Embodiments of the present disclosure provide systems and methods for implementing defined circuit structure pattern identification and placement avoidance in a semiconductor circuit layout of an IC. Disclosed embodiments identify regions of VLSI circuits containing circuits of potentially problematic content from review of physical design data of at least a portion of the integrated circuit. In a disclosed embodiment, each identified circuit containing problematic content along at least one circuit boundary is marked with a keyword. In a disclosed embodiment, a circuit identification textual file that provides various circuit information is updated to store a novel keyword for a given identified problematic circuit. The stored keyword provides a location-specific identifier of each of one or more circuit boundaries including problematic content of the identified problematic circuit.

In one embodiment, the keyword is maintained with the identified problematic circuit throughout the hierarchical construction of the integrated circuit. In a disclosed embodiment, the keyword enables placement avoidance relative to the identified problematic circuit during construction placement of circuits in an IC layout. In a disclosed embodiment, the placement avoidance can ensure reliable circuit performance with sensitive circuits spaced far enough away from the identified circuit boundaries with problematic content. In a disclosed embodiment, a minimum offset or separation space from a given identified circuit boundary with problematic content is provided based on a specific technology of circuits being fabricated, enabling otherwise possible deleterious effects on an adjacent sensitive circuit to be avoided.

In a disclosed embodiment, shapes-based checking is performed to inspect the physical design data and identify regions where the presence, configuration, or characteristic of shapes match predefined patterns known to be problematic. In a disclosed embodiment, shapes-based checking calculates density of a given layer along a circuit to identify such problematic content. For example, problematic content is identified with a calculated density above a predefined threshold value of disclosed embodiments.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

In the following, reference is made to embodiments presented in this disclosure. However, the scope of the present disclosure is not limited to specific described embodiments. Instead, any combination of the following features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

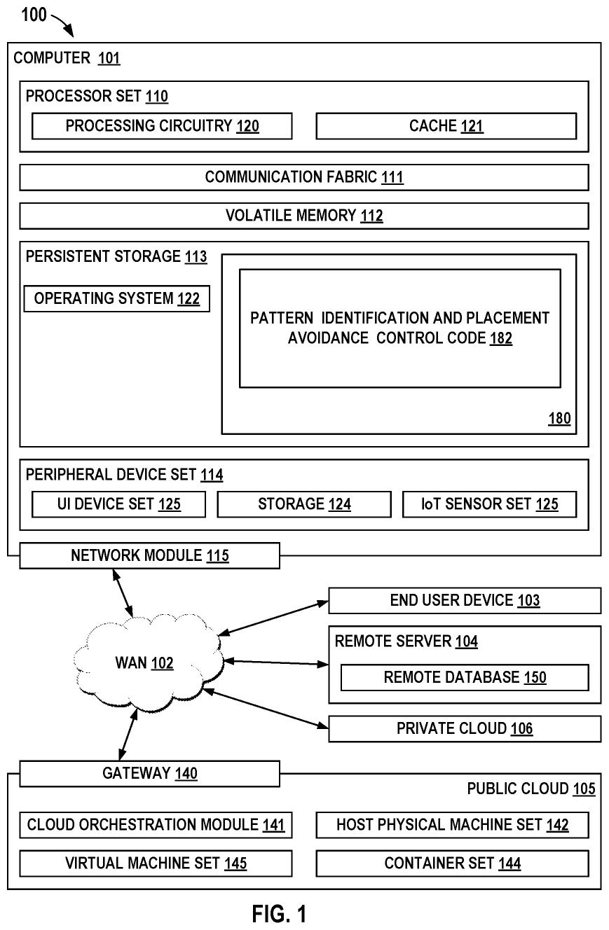

Referring to FIG. 1, a computing environment 100 contains an example of an environment for the execution of at least some of the computer code involved in performing the inventive methods, such as a Defined Circuit Structure Pattern Identification and Placement Avoidance Code 182, at block 180. In addition to block 180, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 180, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 180 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 180 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Disclosed systems and methods enable both effective and efficient circuit structure pattern identification of problematic content and placement avoidance of problematic circuits from other sensitive circuits in accordance with the present disclosure. In a disclosed embodiment, the system identifies regions of circuits containing potentially problematic content from a review of the physical design data, (e.g., performing shapes-based checking of the physical design data) of at least a portion of the integrated circuit, such as predefined circuit shapes forming at least one subcircuit of the integrated circuit. The problematic content corresponds to a defined pattern, of a set of one or more defined patterns. The identified circuits containing problematic content are marked with a keyword, where the identified circuit includes at least one circuit boundary containing the defined pattern. The keyword is maintained with the identified problematic circuit throughout the hierarchical construction of the integrated circuit. The keyword is used during construction placement checking to keep the identified problematic circuits spaced apart from other sensitive circuits in a given integrated circuit layout.

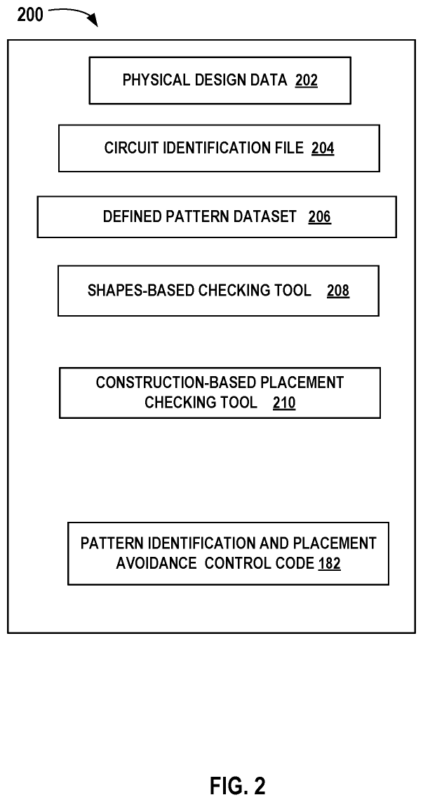

FIG. 2 illustrates an example system 200 for implementing circuit structure pattern identification and placement avoidance of disclosed embodiments. System 200 can be used in conjunction with the computer 101 and cloud environment of the computing environment 100 of FIG. 1 with the Pattern Identification and Placement Avoidance Control Code 182 for implementing methods of the present disclosure.

System 200 includes physical design data 202 for a given integrated circuit. For example, system 200 obtains the physical design data 202 comprising predefined circuit shapes forming at least one subcircuit of the integrated circuit. The predefined circuit shapes include rectangles and polygons, (although other predefined shapes may be used) which represent regions to be manufactured on different layers of an integrated circuit. System 200 includes a circuit identification file 204 to store circuit information for circuits contained in the integrated circuit.

System 200 includes a defined pattern dataset 206 comprising a plurality of certain recognized circuit shape patterns, which can negatively influence transistor performance of nearby circuits. For example, one defined pattern includes a defined circuit density pattern representing a circuit density above a predetermined density ratio value. The defined patterns include certain circuit shape patterns recognized from historical performance analysis of electronic circuits, which indicate problematic circuit content. System 200 includes a shapes-based checking tool 208 comprising computer code, which inspects the physical design data 202 and identifies regions where the presence, configuration or density of circuit shapes match a defined pattern stored in dataset 204, which indicates problematic circuit content.

System 200 includes a construction-based placement checking tool 210 comprising computer code, which is run after the integrated circuit is constructed and checks that each subcircuit of the integrated circuit to determine placement compliance of the identified problematic circuits with the specified separation space in the integrated circuit layout.

In a disclosed embodiment, system 200 enables effective and efficient manufacture of integrated circuits by identifying potentially problematic regions, and marking respective problematic circuits with a keyword providing a location-specific identifier for the problematic circuits. In a disclosed embodiment, system 200 maintains the stored keyword throughout hierarchical construction of the integrated circuit to enable spacing identified problematic circuits apart from other circuits, which have a sensitivity to the problematic content.

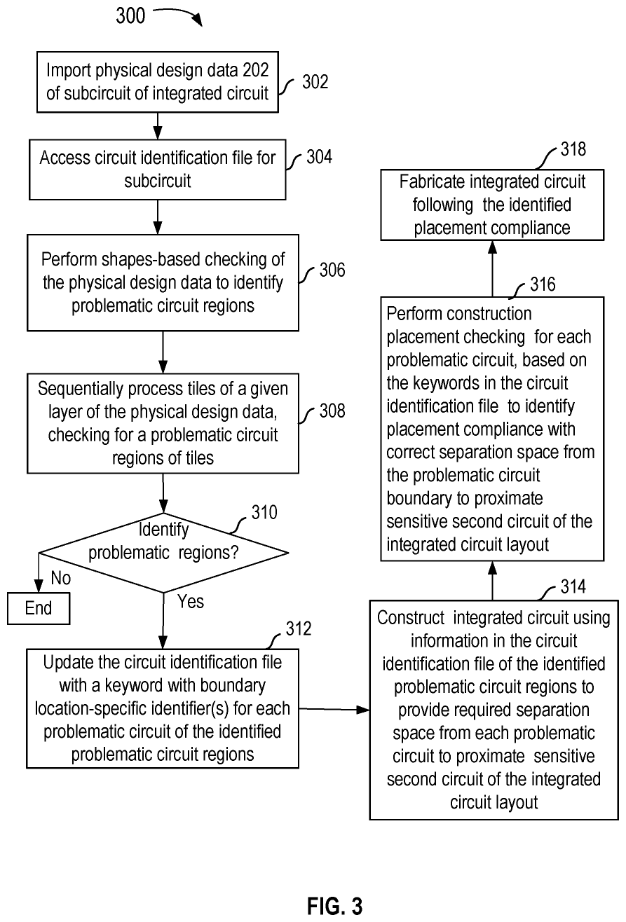

FIG. 3 illustrates of an example method 300 for implementing device changes on a netlist of one or more embodiments of the present disclosure. For example, method 300 is implemented by system 200 including Pattern Identification and Placement Avoidance Control Code 182 used with the computer 101 in accordance with one or more disclosed embodiments of the present disclosure.

Operations of method 300 begin at block 302, system 200 imports physical design data for an integrated circuit, such as physical design data 202 comprising predefined circuit shapes forming at least one subcircuit of the integrated circuit. At block 304, system 200 accesses a circuit identification file for the subcircuit, which contains information relating to a given circuit design which influences where it can be placed, how it should be connected, and the like.

At block 306, system 200 performs shapes-based checking of the physical design data to identify circuit regions containing problematic content. System 200 can identify problematic content of the circuit regions with contain content corresponding to a given defined pattern, such as stored in the defined pattern dataset 206 of FIG. 2.

At block 306, system 200 can perform the shapes-based checking by sequentially processing tiles of a given layer of the physical design data, checking for circuit regions containing problematic content. For example, the tiles have a set area size, such as an area of 6 microns by 6 microns. System 200 sequentially processing tiles of a given area to identify a presence, configuration, or characteristic of a circuit region of tiles matching one given defined pattern. In a disclosed embodiment, system 200 sequentially processes tiles of a given layer of the physical design data to identify, for example a density pattern matching a defined density pattern stored in the defined pattern dataset 206.

At decision block 310, system 200 checks for identified problematic circuit regions. At block 312, system 200 updates the circuit identification file for the subcircuit with a keyword with one or more boundary location-specific identifiers for each identified problematic circuit of the identified problematic circuit regions. For example, the boundary location-specific identifier provides at least one of a north boundary, a south boundary, an east boundary, or a west boundary of the problematic circuit containing the defined pattern.

At block 314, system 200 constructs a given integrated circuit including the processed subcircuit using the information in the circuit identification file with the keyword with boundary location-specific identifiers for each problematic circuit of the identified problematic circuit regions. System 200 constructs the integrated circuit based on the boundary location-specific identifiers for the problematic circuits according to the physical design data 202 with the predefined circuit shapes (e.g., rectangles and polygons) representing all the regions to be manufactured on different layers of an integrated circuit. In a disclosed embodiment, system 200 uses the information in the circuit identification file to make sure that any circuits, whose circuit identification file indicates that the circuit contains problematic content patterns, are appropriately spaced apart from other circuits that are susceptible to the negative effects identified in the integrated circuit layout.

At block 316, system 200 performs construction placement checking, based on the keyword of the problematic circuits, to identify placement compliance with a required separation space from the identified at least one circuit boundary of the problematic circuits to a proximate sensitive second circuit of the integrated circuit layout. For example, system 200 provide changes that may be required in the integrated circuit layout to enable a final signoff to fabricate the integrated circuit. At block 318, system 200 can fabricate an integrated circuit based on the identified placement compliance identified at block 316 of disclosed embodiments.

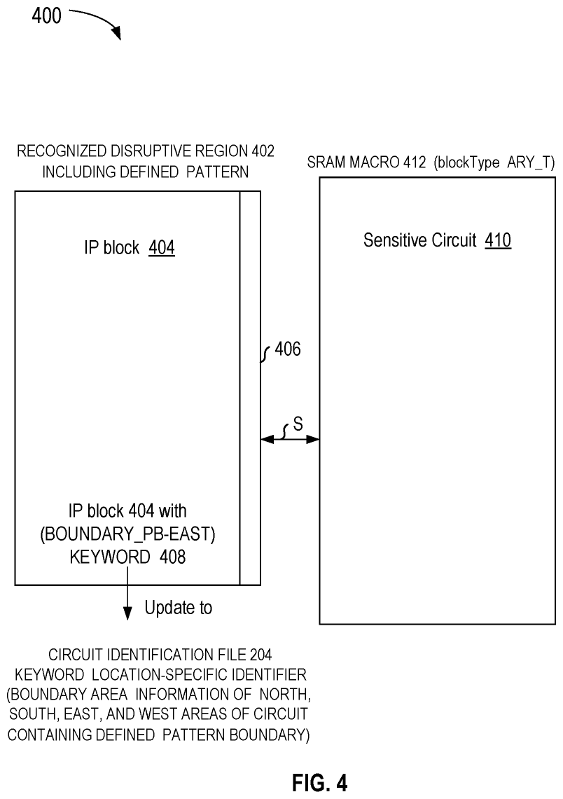

FIG. 4 illustrates an example circuit layout 400 of one or more embodiments of the present disclosure. As shown, the illustrated circuit layout 400 includes a recognized disruptive region 402, which includes a defined pattern indicating problematic content, such as one of the defined patterns of stored in defined pattern dataset 206. FIG. 4 illustrates an IP block 404 (e.g., IP block 404 represents an electronic circuit). For example, the IP block 404 represents an identified circuit containing problematic content and that includes one edge or circuit boundary 406 with a tile containing the defined pattern immediately inside the edge An illustrated keyword BOUNDARY_PB:EAST 408 is used to identify the illustrated problematic boundary 406 of the IP block 404, as shown in FIG. 4. In a disclosed embodiment, the location-specific identifier keyword 408 provides an update to the circuit identification file 204 for the problematic IP circuit block 404. An adjacent sensitive circuit 410 is separated from the circuit boundary 402 by a defined offset indicated by arrow S. For example, the adjacent sensitive circuit 410 can include a static random access memory (SRAM) macro 412 with a block type ARY_T, as shown. In a disclosed embodiment, the minimum offset or separation space S spaces the adjacent sensitive circuit 410 far enough away from the given identified circuit boundary 406 to avoid possible deleterious effects on the sensitive circuit based on a given technology of the integrated circuit being fabricated.

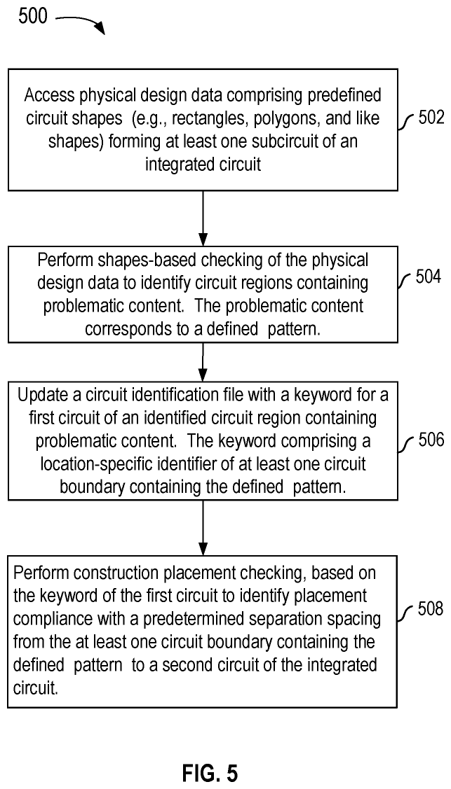

FIG. 5 illustrates an example method 500 for implementing defined circuit structure pattern identification and placement avoidance of one or more disclosed embodiments. The method 500 can be implemented by the system 200 with the Pattern Identification and Placement Avoidance Control Code 182 in conjunction with the computer 101 of FIG. 1 of disclosed embodiments.

At block 502, system 200 accessing physical design data 202 for an integrated circuit. The physical design data 202 comprises predefined circuit shapes forming at least one subcircuit of the integrated circuit. System 200 accesses a circuit identification file 204 associated with the predefined circuit shapes forming the at least one subcircuit. For example, the circuit identification file 204 is a textual file containing information about a given circuit design which relates to where it can be placed, how it should be connected, and the like.

At block 504, system 200 performs shapes-based checking of the physical design data 202 to identify circuit regions containing problematic content. The problematic content corresponds to a defined pattern of a set of defined patterns, such as included in the defined pattern dataset 206 of FIG. 2. For example, the defined patterns represent one or more of a presence, a characteristic, or a configuration of the circuit region known to be problematic, such as indicated from historical investigation of performance on nearby sensitive circuits.

At block 506, system 200 updates a circuit identification file with a keyword for a first circuit of an identified circuit region containing the problematic content. The keyword comprising a location-specific identifier of at least one circuit boundary of the first circuit containing the defined pattern. The keyword is kept with the identified problematic circuit throughout the hierarchical construction of the integrated circuit to enable placement avoidance of sensitive circuits relative to the identified problematic circuits.

At block 508, system 200 performs construction placement checking, based on the keyword of the first circuit, to determine placement compliance with a predetermined separation spacing from the at least one circuit boundary to a second circuit of the integrated circuit, which is determined to be a sensitive circuit. For example the keyword, such as BOUNDARY_PB:EAST as shown in FIG. 4, is used with the illustrated problematic boundary 406 of the IP block 404 throughout the hierarchical construction of the integrated circuit to enable placement avoidance relative to the identified problematic circuit. System 200 provides a minimum offset or separation space from the given identified circuit boundary to the sensitive second circuit.

While the foregoing is directed to embodiments of the present invention, other and further embodiments of the invention may be devised without departing from the basic scope thereof, and the scope thereof is determined by the claims that follow.

What is claimed is:

1. A method comprising:
accessing physical design data for an integrated circuit, the physical design data comprising predefined circuit shapes forming at least one subcircuit of the integrated circuit;
performing shapes-based checking of the physical design data to identify circuit regions containing problematic content, wherein the problematic content corresponds to a defined pattern;
updating a circuit identification file with a keyword for a first circuit of an identified circuit region containing the problematic content, the keyword comprising a location-specific identifier of at least one circuit boundary of the first circuit containing the defined pattern; and
performing construction placement checking, based on the keyword of the first circuit, to determine placement compliance with a predetermined separation spacing from the at least one circuit boundary to a second circuit of the integrated circuit.

2. The method of claim 1, wherein performing shapes-based checking of the physical design data further comprises sequentially processing tiles of a set area size of a given layer of the physical design data to identify a presence, configuration, or characteristic of a circuit region of tiles matching the defined pattern.

3. The method of claim 1, wherein performing shapes-based checking of the physical design data further comprises sequentially processing tiles of a set area size of a given layer of the physical design data to identify a density pattern matching the defined pattern.

4. The method of claim 1, wherein performing shapes-based checking of the physical design data further comprises sequentially processing tiles of a set area size of a given layer of the physical design data to identify a circuit boundary matching the defined pattern.

5. The method of claim 1, wherein accessing physical design data for an integrated circuit further comprises accessing a circuit identification file associated with the predefined circuit shapes forming the at least one subcircuit.

6. The method of claim 1, wherein updating the circuit identification file for the first circuit further comprises providing the location-specific identifier to identify at least one of a north boundary, a south boundary, an east boundary or a west boundary of the first circuit containing the defined pattern.

7. The method of claim 1, wherein the predefined circuit shapes comprise multiple layers of the physical design data and wherein performing shape-based checking further comprises performing shapes-based checking of the multiple layers of the physical design data.

8. The method of claim 1, wherein performing construction placement checking, based on the keyword of the first circuit further comprises checking for a sensitive circuit comprising the second circuit and further comprises providing a separation spacing greater than or equal to the predetermined separation spacing responsive to identifying the sensitive circuit.

9. The method of claim 1, wherein the defined pattern comprises at least one of a predefined configuration of shapes or a density pattern of shapes greater than or equal to a predefined threshold density value.

10. The method of claim 1, wherein performing construction placement checking, based on the keyword of the first circuit further comprises performing circuit placement checking of multiple layers of the physical design data of a layout of the integrated circuit.

11. A system, comprising:
a processor; and
a memory, wherein the memory includes a computer program product configured to perform operations for implementing defined circuit structure pattern identification and placement avoidance in an integrated circuit, the operations comprising:
accessing physical design data for an integrated circuit, the physical design data comprising predefined circuit shapes forming at least one subcircuit of the integrated circuit;
performing shapes-based checking of the physical design data to identify circuit regions containing problematic content, wherein the problematic content corresponds to a defined pattern;
updating a circuit identification file with a keyword for a first circuit of an identified circuit region containing the problematic content, the keyword comprising a location-specific identifier of at least one circuit boundary containing the defined pattern; and
performing construction placement checking, based on the keyword of the first circuit, to determine placement compliance with a predetermined separation spacing from the at least one circuit boundary to a second circuit of the integrated circuit.

12. The system of claim 11, wherein performing shapes-based checking of the physical design data further comprises sequentially processing tiles of a set area size of a given layer of the physical design data to identify a presence, configuration, or characteristic of a circuit region of tiles matching the defined pattern.

13. The system of claim 11, wherein performing shapes-based checking of the physical design data further comprises sequentially processing tiles of a set area size of a given layer of the physical design data to identify a circuit boundary matching the defined pattern.

14. The system of claim 11, wherein updating the circuit identification file for the first circuit further comprises providing the location-specific identifier to identify at least one of a north boundary, a south boundary, an east boundary or a west boundary of the first circuit containing the defined pattern.

15. The system of claim 11, wherein performing construction placement checking, based on the keyword of the first circuit further comprises checking for a sensitive circuit comprising the second circuit and further comprises providing the separation space greater than or equal to a predefined minimum separation space responsive to identifying the sensitive circuit.

16. A computer program product for implementing defined circuit structure pattern identification and placement avoidance in an integrated circuit (IC) design, the computer program product comprising:
a computer-readable storage medium having computer-readable program code embodied therewith, the computer-readable program code executable by one or more computer processors to perform an operation comprising:
accessing physical design data for an integrated circuit, the physical design data comprising predefined circuit shapes forming at least one subcircuit of the integrated circuit;
performing shapes-based checking of the physical design data to identify circuit regions containing problematic content, wherein the problematic content corresponds to a defined pattern;
updating a circuit identification file with a keyword for a first circuit of an identified circuit region containing the problematic content, the keyword comprising a location-specific identifier of at least one circuit boundary containing the defined pattern; and
performing construction placement checking, based on the keyword of the first circuit, to determine placement compliance with a predetermined separation spacing from the at least one circuit boundary to a second circuit of the integrated circuit.

17. The computer program product of claim 16, wherein performing shapes-based checking of the physical design data further comprises sequentially processing tiles of a set area size of a given layer of the physical design data to identify a presence, configuration, or characteristic of a circuit region of tiles matching the defined pattern.

18. The computer program product of claim 16, wherein performing shapes-based checking of the physical design data further comprises sequentially processing tiles of a set area size of a given layer of the physical design data to identify a circuit boundary matching the defined pattern.

19. The computer program product of claim 16, wherein updating the circuit identification file for the first circuit further comprises providing the location-specific identifier to identify at least one of a north boundary, a south boundary, an east boundary or a west boundary of the first circuit containing the defined pattern.

20. The computer program product of claim 16, wherein performing construction placement checking, based on the keyword of the first circuit further comprises checking for a sensitive circuit comprising the second circuit and further comprises providing the separation space greater than or equal to a predefined minimum separation space responsive to identifying the sensitive circuit.
